(19) United States
(12) Patent Application Publication
(10) Pub. No.: US 2005/0251481 A1
(43) Pub. Date: Nov. 10, 2005

(54) Flexible host system for storage media

(75) Inventor: Johan Paul Marie Gerard Linnartz, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkijke Philips Electronics N.V., 5621 BA Eindhoven (NL)

(21) Appl. No.: 10/517,919

(22) PCT Filed: Jun. 11, 2003
(86) PCT No.: PCT/IB03/02574

§ 371 Date: Dec. 14, 2004

(30) Foreign Application Priority Data
Jun. 18, 2002 (EP) 02077406.3

(51) Int. Cl. H04K 1/00; H04L 9/00; G06F 17/60

(52) U.S. Cl. 705/51

(57) ABSTRACT

A system (100) comprising read means (112) for reading content data and control logic data from a storage medium (101), the control logic data being uniquely linked to the storage medium (101), processing means (113-117), for processing the content data and feeding the processed content data to an output, and control means (120) for executing the control logic data and for controlling the processing means (113-117) in accordance with the control logic data being executed. The link is preferably realized by variations in a physical parameter of the storage medium (101) that exhibit a modulation pattern representing a necessary parameter for obtaining access to the control logic data. Alternatively, the link is realized by an integrated circuit (201) on the storage medium (101) which contains the necessary parameter. The necessary parameter may comprise a decryption key or authentication data.

The invention relates to systems for protection of content stored on removable storage media such as optical carriers.

The principle of achieving flexibility through downloadable control software has previously been used in the field of secure rendering. Such a system is known from Bart J. van Rijnsoever, Peter Lenoir and Jean-Paul M. G. Linnartz, “Interoperable protection for digital multimedia content”, IEEE International Multimedia Conference and Exhibit, New York, 2000.

With the current transition from analog to digital platforms for home entertainment, protection of audio and video against illegal copying is becoming a major issue. Technological advances in storage media (such as CD and DVD discs, in particular the recordables or rewritables), networking (the ubiquitous Internet and digital television) and compression (in particular MP3 audio, and MPEG 4 video) not only offer tremendous opportunities for new business models, they also are a threat to the existing businesses of music and film distribution.

Many digital television broadcasters sell their content under the control of a conditional access (CA) system. These systems encrypt an MPEG-2 signal before transmission and send decryption keys to the digital TV terminals (set-top boxes or integrated TV sets) of paying end-users. The terminals decrypt the signal and manage cryptographic keys and content access rights.

OPIMA (Open Platform Initiative for Multimedia Access) is a specification that enables interoperability between content protection systems and multimedia terminals. OPIMA is not restricted to digital TV and includes for example delivery of music through the Internet. Its goal is to create an open market for content delivery. In digital TV and other application areas, content protection systems tend to prevent the development of a horizontal market in which the end-user can use his or her multimedia terminal to access the content offerings of all service providers. Traditionally a terminal supports only one content protection system which severely limits the number of services that can be accessed.

According to OPIMA a generic multimedia terminal is instantiated for a specific Intellectual Property Management and Protection (IPMP) system by downloading a corresponding software module or by inserting a corresponding hardware module. The module implements all functions that differ between different IPMP systems. An OPIMA Virtual Machine (OVM) guarantees the security of the IPMP plug-ins. These plug-ins embody content access rights and the identity of the end-user, so they must be protected from attacks by for example the end-user. How the OVM implements this protection is not defined by OPIMA; it is left as a task for an application domain that adopts OPIMA.

The OVM implements two application programming interfaces (APIs). The Application Services API enables the use of OPIMA by independent applications. Using this API, an application like for example a software player may request access to a specific content item identified by a URL.

The IPMP Services API allows downloaded IPMP plug-ins (or, modules) to access the functionality of the multimedia terminal. The IPMP plug-in implements all functionality that is specific for a specific IPMP system in an application domain. Functions that are common in an application domain (such as transmission and possibly also content decryption) are implemented by the OVM. The OVM also executes most of the rendering, to ensure that the compressed digital content is not available to hackers on an unprotected interface.

While the OPIMA system allows a certain amount of flexibility compared to traditional content protection systems, it suffers from several disadvantages. For one thing, the system requires a communication channel over which the IPMP plug-ins can be downloaded. This channel must be secured and authenticated, so that an attacker cannot manipulate the plug-in as it is being downloaded (e.g. insert a virus or replace code in the plug-in which allows the attacker to make unauthorized copies of the protected content). A return channel is also necessary to request the IPMP plug-ins.

Further, the plug-ins are typically implemented in the lava language, and executed as applets by the OVM. Every content supplier must thus program his own IPMP plug-in with all the necessary functionality. The OPIMA standard defines a generic API for both application services and IPMP services, but an OVM provides no implementation for the functions in this API. This means a lot of duplicated efforts on the part of content suppliers, and it opens up all kinds of security risks as modules are released without adequate scrutiny. It is very hard to correctly implement a security system, and so it is to be expected that many bugs will be found in these implementations, making the entire system seem untrustworthy.

The inventor has realized that a similar technical mechanism can also serve a different purpose. Instead of creating a flexible environment for devices that deliver content to the user (such as television sets, mobile phones, PCs in their function of showing content on the screen), a flexible solution can be achieved for storage and retrieval of content from media such as optical discs.

The inventor has realized that yet another disadvantage is that in the current mindset of OPIMA the IPMP plug-in and the content are delivered over two-way networks supporting authentication. The latter can for instance protect the plug-in against replay attacks. This makes it difficult to store content and the rights associated with it.

It is an object of the invention to provide a system according to the preamble, which provides similar flexibility as prior art systems, but which is more suitable for secure storage of content. Another object of the invention is to give the content owner the freedom to use the appropriate selection of these functions, in a manner that can be defined by control logic.

These and other objects are achieved according to the invention in a system comprising read means for reading content data and control logic data from a storage medium, the control logic data being uniquely linked to the storage medium, processing means, coupled to the read means, for processing the content data and feeding the processed content data to an output, and control means, coupled to the read means, for executing the control logic data and for controlling the processing means in accordance with the control logic data being executed.

The benefits of this architecture are substantial. On the one hand, the processing means can be implemented in a standardized fashion. This reduces the risk of programming and/or security errors in these means, and provides a fixed basic architecture and functionality for the system. On the other hand, by simply writing new control logic data and storing it on a storage medium linked to the storage medium together with content data, the system can be caused to operate in an entirely new way.

As the control logic data is uniquely linked to the storage medium, the system does not require secure channels for downloading plug-ins, and it is more secure against bit-by-bit copying of the contents of the storage medium.

In prior art secure storage systems, a number of functions can be executed by the device that holds the storage medium itself. This functions can include decryption, re-encryption, watermark detection, remarking with a new watermarks, reading out unique identifiers on the disc, reading out and executing revocation messages, comparing the disc type with the content (to prevent playback of professional content intended for pressed media, illegally copied to recordabale media), and so on. The invention now provides for a system in which the content owner has the freedom to use the appropriate selection of these functions, in a manner that can be freely defined by the control logic data.

In an embodiment the read means are arranged for reading out variations in a physical parameter of the storage medium, said variations exhibiting a modulation pattern representing a necessary parameter for obtaining access to the control logic data. In this embodiment the link between control logic data and storage medium is established by requiring the use of the necessary parameter, which is physically part of the storage medium itself and cannot be copied to another storage medium, in order to access the control logic data. The necessary parameter is encoded on the storage medium by introducing variations in a physical parameter of the storage medium, said variations exhibiting a modulation pattern representing the necessary parameter.

Such a physical parameter of a storage medium is sometimes referred to as a “wobble” on the storage medium. Reference is made to U.S. Pat. No. 5,724,327 (attorney docket PHN 13922) to the same assignee as the present invention which describes various techniques to create such a “wobble” and to store information in it.

In a further embodiment the control logic data is stored encrypted on the storage medium, and the necessary parameter comprises a decryption key necessary to decrypt the encrypted control logic data. This is a very simple yet effective technique for requiring the use of the necessary parameter in order to access the control logic data. Without the parameter, the control logic data cannot be recovered. And since the parameter cannot be copied, the control logic data is necessarily linked to the storage medium.

In a further embodiment the necessary parameter comprises authentication data for the control logic data, and the control means are arranged for verifying the authenticity of the control logic data using the authentication data before executing the control logic data An alternative to encrypting the control logic data is to simply store authentication data on the storage medium. If a copy of the storage medium is made, the authentication data cannot be copied, and so authentication of the copy will fail.

In a further embodiment the storage medium comprises an integrated circuit which contains a necessary parameter for obtaining access to the control logic data, and the read means are arranged for reading out the necessary parameter from the integrated circuit. This integrated circuit is sometimes referred to as a “Chip in disc”. Since every storage medium has its own integrated circuit, it is not possible to make a copy of the storage medium with the same information in the integrated circuit. The information from the integrated circuit can then be used to enforce the link between the control logic data and the storage medium.

In a further embodiment the read means are further arranged for storing a value of an additional parameter on the integrated circuit. This allows the system to keep track of, for example, a usage limit to be enforced on access to the content data. The additional parameter could then comprise a counter, which is read out before every access, decreased by one and stored again. If the counter reaches zero, the system refuses access to the content data. The additional parameter could of course also be used for other purposes.

It is a further object of the invention to provide a storage medium comprising content data and control logic data, the control logic data being uniquely linked to the storage medium. This storage medium preferably comprises an optical storage medium.

In an embodiment the storage medium comprises an integrated circuit which contains a necessary parameter for obtaining access to the control logic data In a further embodiment the storage medium exhibits variations in a physical parameter of the storage medium, said variations exhibiting a modulation pattern representing a necessary parameter for obtaining access to the control logic data.

These and other aspects of the invention will be apparent from and elucidated with reference to the embodiments shown in the drawings, in which:

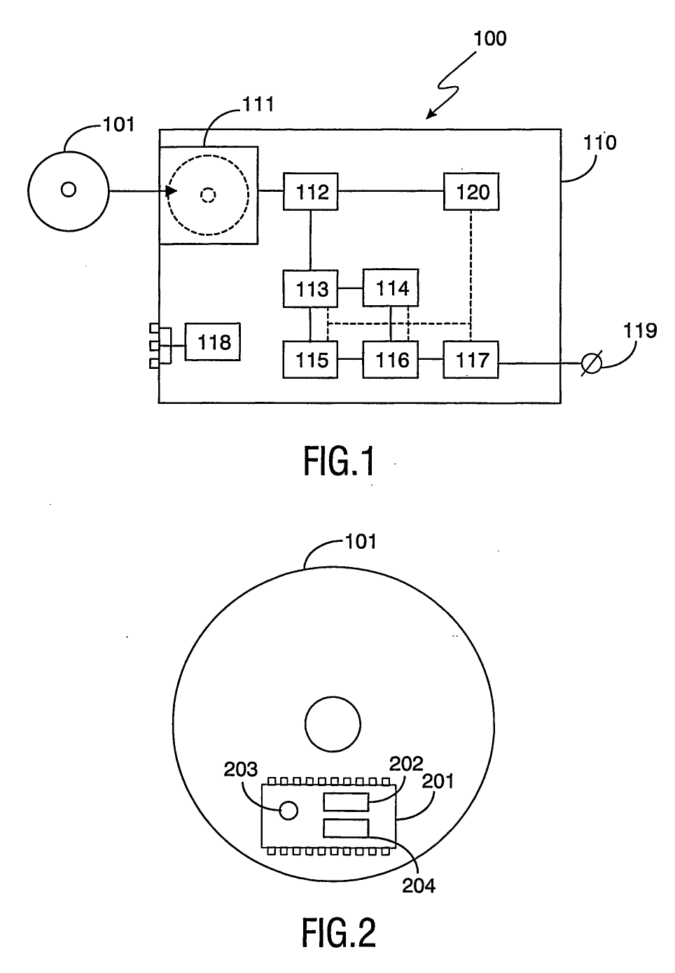

FIG. 1 schematically shows a system comprising a storage medium and a host apparatus in accordance with the invention; and

FIG. 2 schematically shows an embodiment of the storage medium, comprising an integrated circuit, in more detail.

Throughout the figures, same reference numerals indicate similar or corresponding features. Some of the features indicated in the drawings are typically implemented in software, and as such represent software entities, such as software modules or objects.

FIG. 1 schematically shows a system 100 comprising a storage medium 101 and a host apparatus 110 in accordance with the invention. The host apparatus 110 comprises a receptacle 111 in which a user can place the storage medium 101, a read module 112 for reading content data and control logic data from the storage medium 101, various processing means 113-117 for processing the content data and feeding the processed content data to an output 119, and a user input module 118 using which the user can control operation of the host apparatus 110. The host apparatus also comprises a control module 120, whose workings are discussed below.

In FIG. 1, the host apparatus 110 is embodied as an optical disk drive, for example a Compact Disc (CD) or Digital Versatile Disc (DVD) reader. The apparatus 110 could however also easily be embodied as a floppy disc drive or as a reader for storage media such as removable hard disks, smart cards, flash memories and so on. The system 100 of which the host apparatus 110 is a part can be for instance a Compact Disc player, a personal computer, a television or radio system, and so on.

It will be understood that the system 100 can interoperate with a secure rendering system built according to OPIMA-like principles. In such an embodiment the secure flexible host apparatus 110 can establish a two-way communication session with the OPIMA OVM and deliver an IPMP system.

After the user places the storage medium 101 in the receptacle 111, the read module 112 is activated. This activation can be automatic or be in response to a user activation of the user input module 118, for example by pressing a button. In accordance with the present invention, the read module 112 reads the control logic data from the storage medium 101 and feeds the control logic data to the control module 120.

The control module 120 receives the control logic data and attempts to establish that the control logic data is authentic and is correctly linked to the storage medium 101. If this authenticity cannot be established, the control module 120 indicates an error status, for example by supplying an error signal to the output 119 or by activating a LED on the front panel of the host apparatus 110.

One way to establish the unique link between control logic data and storage medium is to require the use of a necessary parameter, which is physically part of the storage medium itself and cannot be copied to another storage medium, in order to access the control logic data. The necessary parameter is encoded on the storage medium by introducing variations in a physical parameter of the storage medium, said variations exhibiting a modulation pattern representing the necessary parameter. Such a physical parameter of a storage medium is sometimes referred to as a “wobble” on the storage medium. Reference is made to U.S. Pat. No. 5,724,327 (attorney docket PHN 13922) to the same assignee as the present invention which describes various techniques to create such a “wobble” and to store information in it.

Preferably the storage medium 101 now is a record carrier of an optical readable type in which the information has been recorded thereon as a pattern of optically detectable marks alternating with intermediate areas arranged along said track thereof. These variations preferably are variations in the track position in a direction transverse to the track direction.

In another embodiment said record carrier, having information marks along a track thereof, exhibits first variations caused by existence and non-existence of the information marks along the track, which first variations represent an information signal recorded on the record carrier, and second variations caused by variations associated with the track, which second variations exhibit a modulation pattern representing a code.

An alternative approach to encode information in a physical parameter of the storage medium uses a modulated pregroove, as described in U.S. Pat. No. 5,901,123 to Pioneer and U.S. Pat. No. 6,075,761 to Sony and Pioneer. Other approaches are of course also possible.

The read module 112 now reads out these variations in a physical parameter of the storage medium, and reconstructs the modulation pattern representing the necessary parameter. This parameter is then supplied to the control module 120.

In a first embodiment, the control logic data is stored encrypted on the storage medium, and the necessary parameter comprises a decryption key necessary to decrypt the encrypted control logic data. Without the parameter, the control logic data cannot be recovered. And since the parameter cannot be copied, the control logic data is necessarily linked to the storage medium 101. As an additional security measure, part of the necessary decryption key could be installed beforehand in the host apparatus 100. The host apparatus 110 combines this part with the decryption information comprised in the necessary parameter to obtain the complete decryption key allowing decryption of the encrypted control logic data.

In a second embodiment the necessary parameter comprises authentication data for the control logic data. The control module 120 now verifies the authenticity of the control logic data using the authentication data before executing the control logic data.

The authentication data may be larger than the amount of data that can be encoded as variations in a physical parameter of the storage medium. In this case the authentication data can be written on the storage medium in a data area, for example in a sector normally used for storing the content data A cryptographic summary of the authentication data is computed and encoded as variations in the physical parameter. Since the summary, for example obtained using the MD5 cryptographic hash function, will be shorter, this summary can be encoded in this way. This option is discussed in more detail in international patent application WO 01/95327 (attorney docket PHNL000303). The necessary parameter now constitutes the cryptographic summary of the authentication data Another way to establish the unique link between control logic data and storage medium is to use a “Chip In Disc” (CID) approach. This approach is described in, for example, international patent application WO 02/17316 (attorney docket PHNL010233) by the same applicant as the present application. This is illustrated in FIG. 2. The storage medium 101, here an optical record carrier like a Compact Disc or DVD, is equipped with an integrated circuit 201, sometimes also called a chip. This integrated circuit comprises means 202 for sending information stored in the circuit to the host apparatus. The chip may be powered using a photodiode 203 to which an external power signal is supplied, although conceivably a battery or other power source could be used.

The information stored in the chip may need to be protected, so that unauthorized devices cannot gain access to it. For example, the information may comprise a content decryption key that should only be supplied to playback devices that conform to a certain Digital Rights Management (DRM) standard. The chip therefore preferably tries to authenticate the host apparatus before sending the stored information to the host apparatus. A low-power authentication method that is well-suited for CID-type applications is described in European patent application serial number 02075983.3 (attorney docket PHNL020192) by the same applicant as the present application.

The information from the integrated circuit can be used to enforce the link between the control logic data and the storage medium similar to the embodiments using a “wobble”: the information comprises a necessary parameter for obtaining access to the control logic data. For example, the information may comprise a decryption key, or comprise authentication data.

In a further embodiment the read module 111 is further arranged for storing a value of an additional parameter on the integrated circuit 201. The integrated circuit 201 to this end comprises a corresponding rewritable storage component 204. This allows the system 100 to keep track of, for example, a usage limit to be enforced on access to the content data. The additional parameter could then comprise a counter, which is read out before every access, decreased by one and stored again. If the counter reaches zero, the system refuses access to the content data. The additional parameter could of course also be used for other purposes. For example, it could be used to hold state information.

In a further embodiment the read module 111 is further arranged for storing a value of an additional parameter elsewhere on the storage medium 101. For instance, the storage medium 101 may comprise a rewritable Digital Versatile Disc or compact disc. This also allows the system 100 to keep track of, for example, a usage limit, state information or other information.

The read module 111 may be arranged to rewrite all or part of the control logic data as it is stored on the storage medium 101. This also allows the system 100 to keep track of, for example, a usage limit, state information or other information. The usage limit now can be implemented simply by assigning it to a variable in the control logic data. The read module 111 can then decrease the usage limit by simply rewriting the assignment statement in the control logic data as it is stored on the storage medium. Alternatively, the read module 111 can modify the control logic data as it is being held in working memory of the host apparatus 110 and then simply replace the control logic data on the storage medium with the modified control logic data.

If the control logic data is modified, this may cause the unique link between control logic data and storage medium to be broken. For instance, if authentication data is stored in the integrated circuit 201 or as variations in a physical parameter of the storage medium, modifications to the control logic data will cause the resulting control logic data to no longer match the authentication data. In case the authentication data is stored in the integrated circuit 201, it may be possible to update this authentication data to reflect the change.

However, if the authentication data is stored as variations in a physical parameter of the storage medium, it is not possible to change the variations. An option that overcomes this problem is to store the authentication data on the storage medium 101 in a rewritable area in encrypted form. A decryption key necessary to decrypt the authentication data is then stored as variations in the physical parameter of the storage medium. The read module 111 can now read out this decryption key and use it to decrypt the authentication data.

After having written the modified control logic data to the storage medium 101, the read module 111 computes the new authentication data (for example, a cryptograpic summary of the modified control logic data), encrypts it using the appropriate key and writes the result to the storage medium 101.

If decryption of the control logic data was successful, and/or authentication of the control logic data was successful, the control module 120 proceeds with executing the control logic data In the host apparatus 110 the control module 120 controls the operations of the processing means 113-117. The control module 120 itself operates in accordance with the control logic data that is being executed.

The control logic data is not just a password or decryption key necessary to gain access to the content data. Rather, it comprises executable code or instructions that are to be carried out by the control module 120. These instructions can be provided in a high-level language, for example an interpreted scripting language such as Python or Tcl/Tk, or in a lower level language such as Java bytecode. Of course the instructions themselves may comprise parameters such as a decryption key or a seed for certain operations to be carried out by the processing means.

The first step in content processing usually will be that the control module 120 activates the read module 112. The read module 112 now reads the content data from the storage medium 101 and feeds it to the processing means 113-117. The output of the processing means 113-117 goes to the output 119, from which the content can be read by other components of the system 100 (e.g. by rendering it as a movie, or generating audio signals to be rendered on loudspeakers). It may be desirable to first let the host apparatus 110 establish that it is installed in a compliant system 100. This is especially important when the output 119 is a digital output. If the compliance of the system 100 cannot be established, no content should be presented on the output 119.

The host apparatus 110 can be equipped with a great variety of processing means. In the exemplary embodiment of FIG. 1, the processing means comprise a decryption module 113, a watermark detection module 114, a conditional access module 115, a signal processing module 116, and a bus encryption module 117.

First, the content as it is read from the storage medium 101 is decrypted by the decryption module 113 under the control of the control logic data as it is being executed by the control module 120. As part of this control, the control module 120 may supply a decryption key to the decryption module 113, or it may direct the decryption module 113 on how to obtain this decryption key. For example, the decryption key could be stored in an integrated circuit contained on the storage medium 101, or on a designated location on the storage medium 101.

The watermark detection module 114 processes the decrypted content data to find a watermark with embedded data contained therein. The watermark could comprise, for example, digital rights management data or an identification of the content owner.

The watermark detection module 114 receives instructions from the control module 120 executing the control logic data on how and where to detect the watermark. For instance, the watermark detection module 114 could be instructed to extract the identification of the content owner and to feed this information to a display module (not shown). Alternatively, the watermark detection module 114 could be instructed to check for a “copy never” or “copy no more” indicator and to signal the conditional access module 115 if such an indicator is found. It could also be the case that the control module 120 does not activate the watermark detection module 114 at all.

The conditional access module 115 is instructed by the control module 120 on how to regulate access to the content data. It could be instructed to enforce a strict no-copying regime, or to not allow the content to be fed to a digital output. In that case, the conditional access module 115 signals to the signal processing module 116 that only analog signals are to be generated and fed to the output 119. The conditional access module 115 could also be instructed to embed a particular type of watermark in the signals to be fed to the output 119.

The signal processing module 116 is responsible for transforming the content data into signals that can be presented on the output 119. This comprises for example generating analog audio and/or video signals, but could also comprise embedding watermark data into signals, filtering out particular portions of the content, generating a trick play version of the content and so on. The exact signal processing or transformation operations to be performed are decided by the control logic data. The control module 120 executing the control logic data controls the operations performed by the signal processing module 116.

The bus encryption module 117 encrypts the audio and/or video signals to be presented on the output 119. For example, the host apparatus 110 could engage in an authentication protocol with another component of the system 100. As a result of this authentication protocol the host apparatus 110 and the other component share a secret key. The content can now be encrypted with the secret key and be presented on the output 119 in encrypted form. This way, other components that can read from the output 119 (for example by listening on the bus to which the output 119 is connected) cannot gain access to the content.

It is important to note that the processing means 113-117 are all components of the host apparatus 110 that may be implemented in whole or in part in software. The control logic data does not provide the host apparatus 110 with completely new functionality, for example an entirely new decryption algorithm. Rather, the control logic data controls the operation of the components of the host apparatus 110 by e.g. activating or not activating particular components, indicating what type of data the components should extract and to which other components they should supply this data

The benefits of this architecture are substantial. On the one hand, all the processing means 113-117 can be implemented in a standardized fashion. This reduces the risk of programming and/or security errors in these means, and provides a fixed basic architecture and functionality for the host apparatus 110. On the other hand, by simply writing new control logic data and storing it on a storage medium linked to the storage medium together with content data, the host apparatus 110 can be caused to operate in an entirely new way.

For example, a content provider could stored content data on the storage medium 101 in encrypted fashion. The control logic data contains instructions which feed the decryption key to the decryption module 113 and to cause the decryption module 113 to feed the decrypted content data directly to the signal processing module 116. The control logic data also contains instructions to indicate to the signal processing module 116 to produce low-quality analog output. The other modules in the host apparatus 110 are not used at all.

The same content provider could later decide to implement a counter-based copy protection mechanism. It adds a “Chip-in-disc” to the storage medium 101 and updates the instructions in the control logic data. The updated instructions now also activate the conditional access module 115 by calling its built-in “Chip-in-disc” reading functions. The conditional access module 115 now reads out the counter stored on the chip 201, checks whether the value is larger than zero, and if so signals to the read module 111 that the content data may be read out. It also reduces the value of the counter by one.

The content provider could also have chosen to implement any other copy protection scheme, as long as the conditional access module 115 contains the necessary functions. It then only needs to write the appropriate instructions in the control logic data, and it can trust that the host apparatus 110 will execute them.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A system (100) comprising read means (112) for reading content data and control logic data from a storage medium (101), the control logic data being uniquely linked to the storage medium (101), processing means (113-117), coupled to the read means (112), for processing the content data and feeding the processed content data to an output, and control means (120), coupled to the read means (112), for executing the control logic data and for controlling the processing means (113-117) in accordance with the control logic data being executed.

2. The system (100) of claim 1, in which the read means (112) are arranged for reading out variations in a physical parameter of the storage medium (101), said variations exhibiting a modulation pattern representing a necessary parameter for obtaining access to the control logic data.

3. The system (100) of claim 2, in which the control logic data is stored encrypted on the storage medium (101), and the necessary parameter comprises a decryption key necessary to decrypt the encrypted control logic data.

4. The system (100) of claim 2, in which the necessary parameter comprises authentication data for the control logic data, and the control means (120) are arranged for verifying the authenticity of the control logic data using the authentication data before executing the control logic data.

5. The system (100) of claim 1, in which the storage medium (101) comprises an integrated circuit (201) which contains a necessary parameter for obtaining access to the control logic data, and the read means (112) are arranged for reading out the necessary parameter from the integrated circuit (201).

6. The system (100) of claim 5, in which the read means (112) are further arranged for storing a value of an additional parameter on the integrated circuit (201).

7. A storage medium (101) comprising content data and control logic data, the control logic data being uniquely linked to the storage medium (101).

8. The storage medium (101) of claim 7, comprising an integrated circuit (201) which contains a necessary parameter for obtaining access to the control logic data.

9. The storage medium (101) of claim 7, exhibiting variations in a physical parameter of the storage medium (101), said variations exhibiting a modulation pattern representing a necessary parameter for obtaining access to the control logic data.

10. The storage medium (101) of claim 7, comprising an optical storage medium.
